(19) United States
(12) Patent Application Publication
(10) Pub. No.: US 2025/0305874 A1
(43) Pub. Date: Oct. 2, 2025

(54) SPECTROSCOPIC ANALYSIS DEVICE

(71) Applicant: HAMAMATSU PHOTONICS K.K., Hamamatsu-shi, Shizuoka (JP)

(72) Inventors: Kouichiro AKIYAMA, Hamamatsu-shi, Shizuoka (JP); Atsushi NAKANISHI, Hamamatsu-shi, Shizuoka (JP); Kazuue FUJITA, Hamamatsu-shi, Shizuoka (JP); Tatsuo DOUGAKIUCHI, Hamamatsu-shi, Shizuoka (JP)

(73) Assignee: HAMAMATSU PHOTONICS K.K., Hamamatsu-shi, Shizuoka (JP)

(21) Appl. No.: 18/863,040

(22) PCT Filed: May 25, 2023
(86) PCT No.: PCT/JP2023/019483

§ 371 Date: Nov. 5, 2024

(30) Foreign Application Priority Data
Jun. 17, 2022 (JP) 2022-097907

(51) Int. Cl. G01J 3/18; G01J 3/02

(52) U.S. Cl. CPC G01J 3/18; G01J 3/0208; G01J 3/0237

(57) ABSTRACT

A spectroscopic analysis device includes a support portion that supports a sample so as to include a predetermined support area; a light source that emits a terahertz wave in a predetermined frequency range; a first off-axis parabolic mirror that collimates the terahertz wave; a first lens that focuses the terahertz wave onto the support area; and a photodetector that detects the terahertz wave with which the sample is irradiated. The light source includes a quantum cascade laser element and a movable diffraction grating. A distance from the light source to the support area via the first off-axis parabolic mirror and the first lens is 10 mm or more and 200 mm or less. An effective diameter of the first lens is 5 mm or more and 80 mm or less. An outer diameter of the support area is 0.5 mm or more and 3.5 mm or less.

### TECHNICAL FIELD

The present disclosure relates to a spectroscopic analysis device.

### BACKGROUND ART

An external resonator type nonlinear quantum cascade laser light source is known as a light source capable of emitting broadband terahertz waves (for example, refer to Patent Literature 1). Since the external resonator type nonlinear quantum cascade laser light source is a light source that is small in size and that can operate at room temperature, the external resonator type nonlinear quantum cascade laser light source is expected to be applied to spectroscopic analysis of a sample.

### CITATION LIST

### Patent Literature

Patent Literature 1: Specification of U.S. Patent Application Publication No. 2015/0311665

### SUMMARY OF INVENTION

### Technical Problem

However, the external resonator type nonlinear quantum cascade laser light source has a problem that the radiation angle of a terahertz wave changes depending on the frequency of the terahertz wave. For that reason, in spectroscopic analysis of the sample, for example, if the sample is not moved according to the frequency of the terahertz wave, the amount of irradiation of the sample with the terahertz wave changes according to the frequency of the terahertz wave, which is a risk.

An object of the present disclosure is to provide a spectroscopic analysis device capable of appropriately performing spectroscopic analysis of a sample using a terahertz wave.

### Solution to Problem

[1] A spectroscopic analysis device according to one aspect of the present disclosure is “a spectroscopic analysis device that includes a support portion that supports a sample so as to include a predetermined support area; a light source that emits a terahertz wave in a predetermined frequency range; a first off-axis parabolic mirror that collimates the terahertz wave emitted from the light source; a first lens that focuses the terahertz wave onto the support area, the terahertz wave being collimated by the first off-axis parabolic mirror; and a photodetector that detects the terahertz wave with which the sample is irradiated, in which the light source includes a quantum cascade laser element that generates a first light of a first frequency and a second light of a second frequency, and that emits the terahertz wave of a difference frequency between the first frequency and the second frequency, and a movable diffraction grating that constitutes an external resonator for the first light, and that changes the first frequency by changing an angle of a diffraction grating pattern with respect to the quantum cascade laser element, a distance from the light source to the support area via the first off-axis parabolic mirror and the first lens is 10 mm or more and 200 mm or less, an effective diameter of the first lens is 5 mm or more and 80 mm or less, and an outer diameter of the support area is 0.5 mm or more and 3.5 mm or less”.

In the spectroscopic analysis device described in [1], the terahertz wave in the predetermined frequency range substantially passes through a portion within the effective diameter of the first lens, and a focused spot of the terahertz wave in the predetermined frequency range is substantially contained in the support area. Here, the sample is supported to include the very small support area having an outer diameter of 0.5 mm or more and 3.5 mm or less. Therefore, during spectroscopic analysis of the sample, for example, even when the sample is not moved according to the frequency of the terahertz wave, the amount of irradiation of the sample with the terahertz wave is maintained substantially constant. No need to move the sample according to the frequency of the terahertz wave leads to a simplification of the structure of the support portion and to shortening the analysis time. Therefore, according to the spectroscopic analysis device described in [1], the spectroscopic analysis of the sample using the terahertz wave can be appropriately performed.

[2] The spectroscopic analysis device according to one aspect of the present disclosure may be “the spectroscopic analysis device described in [1], further including a second lens that collimates the terahertz wave with which the sample is irradiated”. According to the spectroscopic analysis device described in [2], the terahertz wave with which the sample is irradiated can be appropriately incident on the photodetector.

[3] The spectroscopic analysis device according to one aspect of the present disclosure may be “the spectroscopic analysis device described in [1] or [2], further including a second off-axis parabolic mirror that focuses the terahertz wave onto the photodetector, the sample being irradiated with the terahertz wave”. According to the spectroscopic analysis device described in [3], the terahertz wave with which the sample is irradiated can be appropriately incident on the photodetector.

[4] The spectroscopic analysis device according to one aspect of the present disclosure may be “the spectroscopic analysis device described in any of [1] to [3], further including a housing in which a replacement with an inert gas or an evacuation is performed, in which at least the light source, the first off-axis parabolic mirror, the first lens, and the photodetector are disposed inside the housing”. According to the spectroscopic analysis device described in [4], the terahertz wave with which the sample is to be irradiated and the terahertz wave with which the sample is irradiated can be prevented from being absorbed by moisture, and the detection sensitivity of the terahertz wave can be improved.

[5] The spectroscopic analysis device according to one aspect of the present disclosure may be “the spectroscopic analysis device described in [4] in which the support portion is disposed outside the housing, the housing includes a first wall and a second wall facing the support area on both sides of the support area, the first wall is provided with a first window portion that transmits the terahertz wave, and the second wall is provided with a second window portion that transmits the terahertz wave”. According to the spectroscopic analysis device described in [5], it is possible to perform the disposition and the like of the sample with respect to the support portion while maintaining a state where the replacement with an inert gas or the evacuation is performed in the housing.

[6] The spectroscopic analysis device according to one aspect of the present disclosure may be “the spectroscopic analysis device described in [5] in which when viewed in a direction in which the support area and the first wall face each other, an outer diameter of the first window portion is 1 time or more and 10 times or less the outer diameter of the support area”. According to the spectroscopic analysis device described in [6], an irradiation position of the terahertz wave is easily identified.

[7] The spectroscopic analysis device according to one aspect of the present disclosure may be “the spectroscopic analysis device described in any of [1] to [6] in which a position of each of the support portion and the photodetector is fixed when the movable diffraction grating changes the angle of the diffraction grating pattern”. According to the spectroscopic analysis device described in [7], the structures of the support portion and the photodetector can be simplified.

[8] The spectroscopic analysis device according to one aspect of the present disclosure may be “the spectroscopic analysis device described in any of [1] to [7] in which a position of each of the first off-axis parabolic mirror and the first lens is fixed when the movable diffraction grating changes the angle of the diffraction grating pattern”. According to the spectroscopic analysis device described in [8], the structures of the first off-axis parabolic mirror and the first lens can be simplified.

[9] The spectroscopic analysis device according to one aspect of the present disclosure may be “the spectroscopic analysis device according to any of [1] to [8] in which the frequency range is 0.5 THz or more and 5.0 THz or less”. According to the spectroscopic analysis device described in [9], the spectroscopic analysis of the sample using the terahertz wave can be performed over a wide frequency range.

### Advantageous Effects of Invention

According to the present disclosure, it is possible to provide the spectroscopic analysis device capable of appropriately performing spectroscopic analysis of the sample using the terahertz wave.

### BRIEF DESCRIPTION OF DRAWINGS

FIG. 1 is a configuration view of a spectroscopic analysis device of one embodiment.

FIG. 2 is a configuration view of a light source shown in FIG. 1.

FIG. 3 is a view showing a focused state of a terahertz wave according to a first simulation and a focused state of a terahertz wave according to a second simulation.

FIG. 4 is a configuration view of a spectroscopic analysis device according to a first modification example.

FIG. 5 is a configuration view of a spectroscopic analysis device according to a second modification example.

### DESCRIPTION OF EMBODIMENTS

Hereinafter, an embodiment of the present disclosure will be described in detail with reference to the drawings. Incidentally, in the drawings, the same or corresponding portions are denoted by the same reference signs, and duplicate descriptions will be omitted.

### Configuration of Spectroscopic Analysis Device

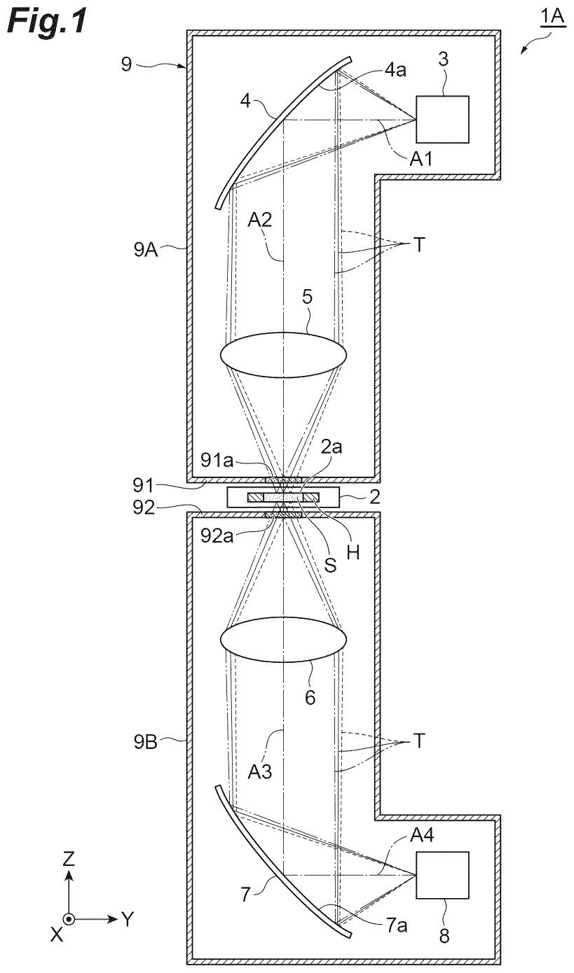

As shown in FIG. 1, a spectroscopic analysis device 1A includes a support portion 2, a light source 3, a first off-axis parabolic mirror 4, a first lens 5, a second lens 6, a second off-axis parabolic mirror 7, a photodetector 8, and a housing 9. The spectroscopic analysis device 1A performs spectroscopic analysis of a sample S by irradiating the sample S with a terahertz wave T in a predetermined frequency range and detecting the terahertz wave T that has transmitted through the sample S.

The support portion 2 supports the sample S so as to include a predetermined support area 2a. The support area 2a is a circular area. The support portion 2 supports the sample S such that the terahertz wave T can pass through the sample S along a direction perpendicular to the support area 2a. In the present embodiment, the support portion 2 supports the sample S formed in a plate shape, in a state where the sample S is held by a holder H having an annular shape. Hereinafter, the direction perpendicular to the support area 2a is referred to as a Z direction, one direction perpendicular to the Z direction is referred to as an X direction, and a direction perpendicular to both the Z direction and the X direction is referred to as a Y direction.

The light source 3 is an external resonator type nonlinear quantum cascade laser light source, and emits the terahertz wave T in the predetermined frequency range. In the present embodiment, the light source 3 emits the terahertz wave T along the Y direction. The frequency range of the terahertz wave T emitted from the light source 3 is 0.5 THz or more and 5.0 THz or less.

The first off-axis parabolic mirror 4 collimates the terahertz wave T emitted from the light source 3. The first off-axis parabolic mirror 4 has a mirror surface 4a that collimates the terahertz wave T, and that reflects the terahertz wave T. In the present embodiment, the first off-axis parabolic mirror 4 reflects the terahertz wave T so as to change a traveling direction of the terahertz wave T from the Y direction to the Z direction.

Incidentally, the first off-axis parabolic mirror 4 is not limited to collimating the terahertz wave T into completely parallel light, and may substantially collimate the terahertz wave T.

The first lens 5 focuses the terahertz wave T onto the support area 2a, the terahertz wave T being collimated by the first off-axis parabolic mirror 4. Namely, the first lens 5 focuses the terahertz wave T such that a focused spot of the terahertz wave T is located on the support area 2a. In the present embodiment, the first lens 5 transmits the terahertz wave T along the Z direction, and focuses the terahertz wave T. The first lens 5 has a numerical aperture that allows the terahertz wave T to be focused such that a diameter of the focused spot of the terahertz wave T on the support area 2a (=(1.22×wavelength)/numerical aperture) is 1 mm or less. However, the diameter of the focused spot of the terahertz wave T on the support area 2a may be 1 mm or more.

The second lens 6 collimates the terahertz wave T with which the sample S is irradiated. Namely, the second lens 6 collimates the terahertz wave T that has transmitted through the sample S, and that is in a diverged state. In the present embodiment, the second lens 6 transmits the terahertz wave T along the Z direction, and collimates the terahertz wave T.

Incidentally, the second lens 6 is not limited to collimating the terahertz wave T into completely parallel light, and may substantially collimate the terahertz wave T.

The second off-axis parabolic mirror 7 focuses the terahertz wave T onto the photodetector 8, the terahertz wave T being collimated by the second lens 6 (namely, the terahertz wave T with which the sample S is irradiated). The second off-axis parabolic mirror 7 has a mirror surface 7a that focuses the terahertz wave T, and that reflects the terahertz wave T. In the present embodiment, the second off-axis parabolic mirror 7 reflects the terahertz wave T so as to change a traveling direction of the terahertz wave T from the Z direction to the Y direction.

The photodetector 8 detects the terahertz wave T focused by the second off-axis parabolic mirror 7 (namely, the terahertz wave T with which the sample S is irradiated). The photodetector 8 is, for example, a Golay cell, a bolometer, or the like.

The housing 9 is a housing in which a replacement with an inert

gas or an evacuation is performed. The light source 3, the first off-axis parabolic mirror 4, the first lens 5, the second lens 6, the second off-axis parabolic mirror 7, and the photodetector 8 are disposed inside the housing 9. More specifically, the light source 3, the first off-axis parabolic mirror 4, and the first lens 5 are disposed inside a first portion 9A of the housing 9, and the second lens 6, the second off-axis parabolic mirror 7, and the photodetector 8 are disposed inside a second portion 9B of the housing 9. The support portion 2 is disposed outside the housing 9. As one example, the inside of the housing 9 is purged with nitrogen gas. The housing 9 includes a first wall 91 and a second wall 92 facing

the support area 2a on both sides of the support area 2a. In the present embodiment, the first wall 91 is a part of a wall constituting the first portion 9A, and the second wall 92 is a part of a wall constituting the second portion 9B. The first wall 91 is provided with a first window portion 91a that transmits the terahertz wave T. The first window portion 91a faces the support area 2a in the Z direction. The first window portion 91a has a size sufficient to include the support area 2a when viewed in the

Z direction that is a direction in which the support area 2a and the first wall 91 face each other. Namely, when viewed in the Z direction that is a direction in which the support area 2a and the first wall 91 face each other, an outer edge of the first window portion 91a is located outside an outer edge of the support area 2a. Specifically, when viewed in the Z direction, an outer diameter of the first window portion 91a is 1 time or more and 10 times or less an outer diameter of the support area 2a. The outer diameter of the first window portion 91a is, for example, approximately 20 mm. The second wall 92 is provided with a second window portion 92a that transmits the terahertz wave T. The second window portion 92a faces the support area 2a in the Z direction. Similarly to the first window portion 91a, the second window portion 92a has a size sufficient to include the support area 2a when viewed in the Z direction. A material of the first window portion 91a and the second window portion 92a is, for example, synthetic quartz, plastic, or the like.

### Configuration of Light Source

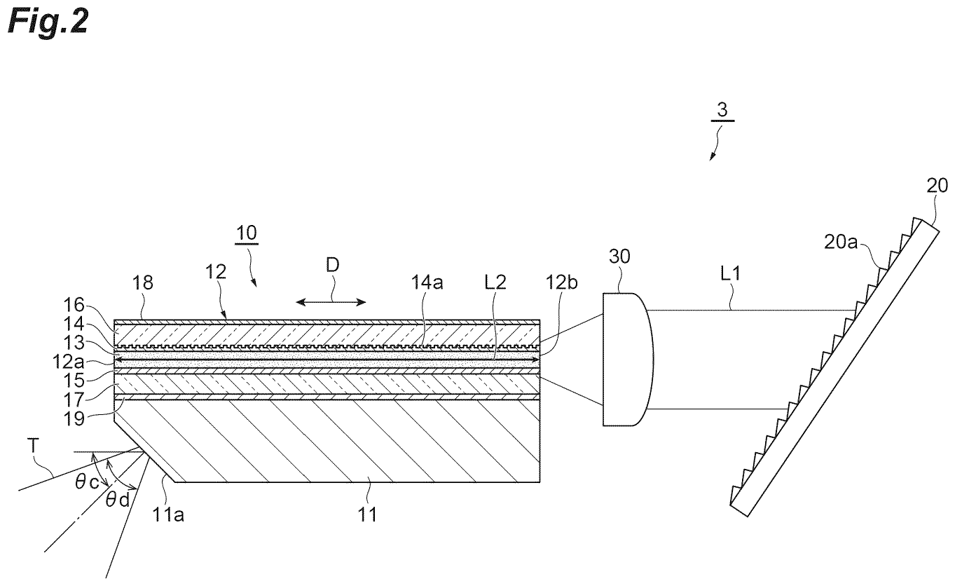

As shown in FIG. 2, the light source 3 includes a quantum cascade laser element 10. The quantum cascade laser element 10 includes a semiconductor substrate 11 and a semiconductor layer 12. The semiconductor layer 12 is an epitaxial growth layer formed on one surface of the semiconductor substrate 11. The quantum cascade laser element 10 is formed in a bar shape with a direction D as a longitudinal direction. The direction D is a direction perpendicular to a thickness direction of the semiconductor substrate 11. The semiconductor layer 12 has a first end surface 12a and a second end surface 12b facing each other in the direction D. The first end surface 12a and the second end surface 12b are, for example, cleavage surfaces.

The semiconductor substrate 11 is, for example, an InP single crystal substrate having a rectangular plate shape with the direction D as a longitudinal direction. A length, width, and thickness of the semiconductor substrate 11 are approximately several hundred um to several mm, approximately several hundred μm to several mm, and approximately several hundred μm, respectively. The semiconductor substrate 11 has a side surface 11a. The side surface 11a is an inclined surface formed between a side surface of the semiconductor substrate 11, which is continuous from the first end surface 12a, and the other surface on an opposite side of the semiconductor substrate 11 from the semiconductor layer 12. An angle between the first end surface 12a and the side surface 11a is, for example, approximately 120 to 170°. The side surface 11a is, for example, a polished surface.

The semiconductor layer 12 includes an active layer 13, an upper guide layer 14, a lower guide layer 15, an upper cladding layer 16, a lower cladding layer 17, an upper contact layer 18, and a lower contact layer 19. The lower contact layer 19, the lower cladding layer 17, the lower guide layer 15, the active layer 13, the upper guide layer 14, the upper cladding layer 16, and the upper contact layer 18 are laminated on the semiconductor substrate 11 in order.

The lower contact layer 19 is, for example, an InGaAs layer (Si doped: 1.5×10¹⁸ cm⁻³) having a thickness of approximately 400 nm. The lower cladding layer 17 is, for example, an InP layer (Si doped: 1.5×10¹⁶ cm⁻³) having a thickness of approximately 5 μm. The lower guide layer 15 is, for example, an InGaAs layer (Si doped: 1.5×10¹⁶ cm⁻³) having a thickness of approximately 250 nm. The active layer 13 is a layer having a quantum cascade structure. The active layer 13 includes, for example, a plurality of InGaAs layers and a plurality of InAlAs layers that are alternately laminated one by one. The upper guide layer 14 is, for example, an InGaAs layer (Si doped: 1.5×10¹⁶ cm⁻³) having a thickness of approximately 450 nm. In the upper guide layer 14, a diffraction grating layer 14a functioning as a distributed feedback (DFB) structure is formed along the direction D. The upper cladding layer 16 is, for example, an InP layer (Si doped: 1.5×10¹⁶ cm⁻³) having a thickness of approximately 5 μm.

The upper contact layer 18 is, for example, an InP layer (Si doped: 1.5×10¹⁸ cm⁻³) having a thickness of approximately 15 nm.

The light source 3 further includes a movable diffraction grating 20 and a lens 30. The movable diffraction grating 20 has a diffraction grating pattern 20a. The diffraction grating pattern 20a faces the second end surface 12b of the quantum cascade laser element 10 in the direction D. The movable diffraction grating 20 is configured to oscillate the diffraction grating pattern 20a about an axis parallel to the first end surface 12a and perpendicular to the direction D. The movable diffraction grating 20 is, for example, a micro-electromechanical systems (MEMS) movable diffraction grating device. The lens 30 is disposed between the second end surface 12b and the diffraction grating pattern 20a. The lens 30 collimates a first light L1 (to be described later) emitted from the second end surface 12b and causes the first light L1 to be incident on the diffraction grating pattern 20a, and the lens 30 focuses the first light L1 reflected by the diffraction grating pattern 20a and causes the first light L1 to be incident on the second end surface 12b.

In the light source 3 configured as described above, the quantum cascade laser element 10 generates the first light L1 of a first frequency ω₁ and a second light L2 of a second frequency ω₂, and emits the terahertz wave T of a difference frequency ω₃ (=|ω₁−ω₂|) between the first frequency ω₁ and the second frequency ω₂. The movable diffraction grating 20 constitutes an external resonator for the first light L1, and changes the first frequency ω₁ by changing the angle of the diffraction grating pattern 20a with respect to the quantum cascade laser element 10.

More specifically, in the active layer 13, the first light L1 of the first frequency ω₁ and the second light L2 of the second frequency ω₂ which are light in a mid-infrared range are generated. The first light L1 of the first frequency ω₁ is oscillated in a single mode due to the first end surface 12a and the diffraction grating pattern 20a functioning as a resonator. The second light L2 of the second frequency ω₂ is oscillated in a single mode due to the diffraction grating layer 14a functioning as a distributed feedback structure and the first end surface 12a and the second end surface 12b functioning as a resonator. As a result, in the active layer 13, the terahertz wave T of the difference frequency ω₃ between the first frequency ω₁ and the second frequency ω₂ is generated by difference frequency generation. At this time, when the movable diffraction grating 20 changes the angle of the diffraction grating pattern 20a with respect to the second end surface 12b, the first frequency ω₁ of the first light L1 that feedbacks from the diffraction grating pattern 20a to the second end surface 12b changes, and accordingly, the difference frequency ω₃ also changes. Therefore, the terahertz wave T in the predetermined frequency range can be emitted from the quantum cascade laser element 10 by Cherenkov phase matching.

The terahertz wave T is emitted from the side surface 11a of the quantum cascade laser element 10 at a radiation angle θc and a divergence angle θd. The radiation angle θc is an angle that a center line of the terahertz wave T forms with respect to the direction D. The divergence angle θd is an angle of spread of the terahertz wave T. The radiation angle θc changes depending on the frequency of the terahertz wave T (namely, the difference frequency ω₃). For example, there is a difference of approximately 2.7° in the radiation angle θc between the terahertz wave T of 2.0 THz and the terahertz wave T of 3.0 THz. The divergence angle θd is approximately 50°.

### Disposition and Dimension of Each Configuration in Spectroscopic Analysis Device

As shown in FIG. 1, the light source 3 has an optical axis A1 parallel to the Y direction. The optical axis A1 is an optical axis of a light-emitting unit (for example, a light-emitting lens or the like) of the light source 3 from which the terahertz wave T is emitted. The first lens 5 has an optical axis A2 parallel to the Z direction. The second lens 6 has an optical axis A3 parallel to the Z direction. The photodetector 8 has an optical axis A4 parallel to the Y direction. The optical axis A4 is an optical axis of a light-incident unit (for example, a light-incident window member or the like) of the photodetector 8 on which the terahertz wave T is incident. The optical axis A1 and the optical axis A2 intersect the mirror surface 4a of the first off-axis parabolic mirror 4 at the same position on the mirror surface 4a. The optical axis A3 and the optical axis A4 intersect the mirror surface 7a of the second off-axis parabolic mirror 7 at the same position on the mirror surface 7a. The optical axis A2 and the optical axis A3 intersect the support area 2a at the same position on the support area 2a.

A distance from the light source 3 to the support area 2a via the first off-axis parabolic mirror 4 and the first lens 5 (namely, an actual distance along an “optical path from the light source 3 to the support area 2a via the first off-axis parabolic mirror 4 and the first lens 5”) (hereinafter, referred to as “a distance from the light source 3 to the support area 2a”) is 10 mm or more and 200 mm or less. Namely, the sum of “a distance from an intersection point between the optical axis A1 and a light-emitting surface of the light-emitting unit of the light source 3 to an intersection point between the optical axis A1 and the mirror surface 4a of the first off-axis parabolic mirror 4” and “a distance from an intersection point between the optical axis A2 and the mirror surface 4a of the first off-axis parabolic mirror 4 to an intersection point between the optical axis A2 and the support area 2a” is 10 mm or more and 200 mm or less. An effective diameter of the first lens 5 is 5 mm or more and 80 mm or less. The outer diameter of the support area 2a is 0.5 mm or more and 3.5 mm or less.

When (i) the frequency range of the terahertz wave T emitted from the light source 3 is 0.5 THz or more and 5.0 THz or less, (ii) the first lens 5 has a numerical aperture that allows the terahertz wave T to be focused such that the diameter of the focused spot of the terahertz wave T on the support area 2a is 1 mm or less, (iii) the effective diameter of the first lens 5 is 5 mm or more and 80 mm or less, and (iv) the outer diameter of the support area 2a is 0.5 mm or more and 3.5 mm or less, if the distance from the light source 3 to the support area 2a is 200 mm or less, the spectroscopic analysis device 1A can be configured such that the terahertz wave T substantially passes through a portion within the effective diameter of the first lens 5 and the focused spot of the terahertz wave T is substantially contained in the support area 2a. For that reason, in the spectroscopic analysis device 1A, the position of each of the support portion 2, the first off-axis parabolic mirror 4, the first lens 5, the second lens 6, the second off-axis parabolic mirror 7, and the photodetector 8 is fixed even when the movable diffraction grating 20 changes the angle of the diffraction grating pattern 20a.

Incidentally, if the distance from the light source 3 to the support area 2a is shorter than 10 mm, the disposition of each configuration becomes physically difficult. For that reason, in the spectroscopic analysis device 1A, the distance from the light source 3 to the support area 2a is set to 10 mm or more. In addition, if the effective diameter of the first lens 5 is larger than 80 mm, the first lens 5 is made thicker to ensure the numerical aperture of the first lens 5, and the amount of attenuation of the terahertz wave T by the first lens 5 increases. For that reason, in the spectroscopic analysis device 1A, the effective diameter of the first lens 5 is set to 80 mm or less. In addition, even when by shortening the distance from the light source 3 to the support area 2a, the diameter of the first off-axis parabolic mirror 4 is reduced, and the beam diameter of the terahertz wave T before being focused by the first lens 5 is also reduced, by setting the effective diameter of the first lens 5 to 5 mm or more, the terahertz wave T emitted from the light source 3 can be sufficiently focused in the support area 2a.

For reference, the distance from the intersection point between the optical axis A1 and the light-emitting surface of the light-emitting unit of the light source 3 to the intersection point between the optical axis A1 and the mirror surface 4a of the first off-axis parabolic mirror 4 is 1 mm or more and 100 mm or less. The distance from the intersection point between the optical axis A2 and the mirror surface 4a of the first off-axis parabolic mirror 4 to the intersection point between the optical axis A2 and the support area 2a is 4 mm or more and 199 mm or less. A distance from the intersection point between the optical axis A2 and the mirror surface 4a of the first off-axis parabolic mirror 4 to the center of the first lens 5 is 1 mm or more and 199 mm or less. Incidentally, the first lens 5 may be composed of a plurality of lenses. In that case, the effective diameter of the first lens 5 means an effective diameter of the lens closest to the support area 2a, and the center of the first lens 5 means the center of the lens closest to the support area 2a.

### Actions and Effects

In the spectroscopic analysis device 1A, the terahertz wave T in the predetermined frequency range substantially passes through a portion within the effective diameter of the first lens 5, and the focused spot of the terahertz wave T in the predetermined frequency range is substantially contained in the support area 2a. Here, the sample S is supported to include the very small support area 2a having an outer diameter of 0.5 mm or more and 3.5 mm or less. Therefore, during spectroscopic analysis of the sample S, for example, even when the sample S is not moved according to the frequency of the terahertz wave T, the amount of irradiation of the sample S with the terahertz wave T is maintained substantially constant. No need to move the sample S according to the frequency of the terahertz wave T leads to a simplification of the structure of the support portion 2 (simplification in both hardware and software aspects), in turn, to a reduction in the size of the spectroscopic analysis device 1A, and further leads to shortening the analysis time. Therefore, according to the spectroscopic analysis device 1A, spectroscopic analysis of the sample S using the terahertz wave T can be appropriately performed.

In the spectroscopic analysis device 1A, the terahertz wave T with which the sample S is irradiated is collimated by the second lens 6. Accordingly, the terahertz wave T with which the sample S is irradiated can be appropriately incident on the photodetector 8.

In the spectroscopic analysis device 1A, the terahertz wave T with which the sample S is irradiated is focused onto the photodetector 8 by the second off-axis parabolic mirror 7. Accordingly, the terahertz wave T with which the sample S is irradiated can be appropriately incident on the photodetector 8.

In the spectroscopic analysis device 1A, the light source 3, the first off-axis parabolic mirror 4, the first lens 5, the second lens 6, the second off-axis parabolic mirror 7, and the photodetector 8 are disposed the housing 9 in which a replacement with an inert gas or an evacuation is performed. Accordingly, the terahertz wave T with which the sample S is to be irradiated and the terahertz wave T with which the sample S is irradiated can be prevented from being absorbed by moisture, and the detection sensitivity of the terahertz wave T can be improved. In the spectroscopic analysis device 1A, the support portion 2 is disposed outside the housing 9, the first window portion 91a that transmits the terahertz wave T is provided on the first wall 91 of the housing 9 which faces the support area 2a, and the second window portion 92a that transmits the terahertz wave T is provided on the second wall 92 of the housing 9 which faces the support area 2a. Accordingly, it is possible to perform the disposition and the like of the sample S with respect to the support portion 2 while maintaining a state where the replacement with an inert gas or the evacuation is performed in the housing 9.

In the spectroscopic analysis device 1A, when viewed in the Z direction, the outer diameter of the first window portion 91a is 1 time or more and 10 times or less the outer diameter of the support area 2a. Accordingly, an irradiation position of the terahertz wave T is easily identified.

In the spectroscopic analysis device 1A, the position of each of the

support portion 2, the first off-axis parabolic mirror 4, the first lens 5, the second lens 6, the second off-axis parabolic mirror 7, and the photodetector 8 is fixed even when the movable diffraction grating 20 changes the angle of the diffraction grating pattern 20a. Accordingly, the structures of the support portion 2, the first off-axis parabolic mirror 4, the first lens 5, the second lens 6, the second off-axis parabolic mirror 7, and the photodetector 8 can be simplified.

In the spectroscopic analysis device 1A, the frequency range of the terahertz wave T emitted from the light source 3 is 0.5 THz or more and 5.0 THz or less. Accordingly, the spectroscopic analysis of the sample S using the terahertz wave T can be performed over a wide frequency range.

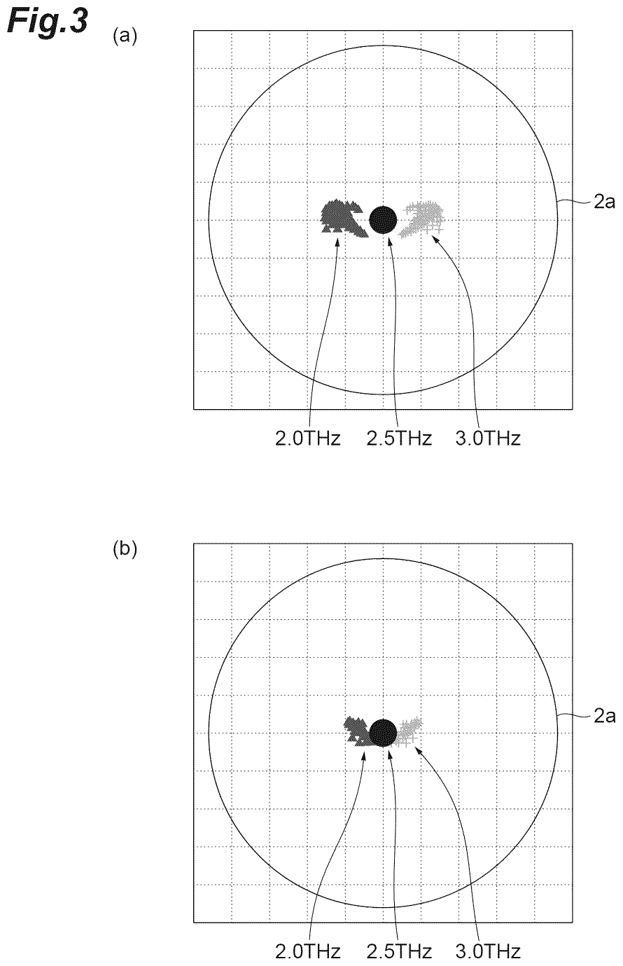

(a) in FIG. 3 is a view showing a focused state of the terahertz wave T according to a first simulation. Conditions for the first simulation were as follows: “the first off-axis parabolic mirror 4 having a parabolic surface with a diameter of 3 inches and a focal length of 2 inches” and “the first lens 5 having an effective diameter of 45 mm and a numerical aperture of 0.5625 mm” were used, “the distance from the intersection point between the optical axis A1 and the light-emitting surface of the light-emitting unit of the light source 3 to the intersection point between the optical axis A1 and the mirror surface 4a of the first off-axis parabolic mirror 4” was set to 50.8 mm, “the distance from the intersection point between the optical axis A2 and the mirror surface 4a of the first off-axis parabolic mirror 4 to the intersection point between the optical axis A2 and the support area 2a” was set to 105 mm, and “the distance from the intersection point between the optical axis A2 and the mirror surface 4a of the first off-axis parabolic mirror 4 to the center of the first lens 5” was set to 65 mm. In this case, the distance from the light source 3 to the support area 2a is 155 mm.

As a result of the first simulation, as shown in (a) in FIG. 3, the amount of deviation of the “center of a focused spot of the terahertz wave T of 2.0 THz” from the “center of a focused spot of the terahertz wave T of 2.5 THz” was approximately −0.2 mm, and the amount of deviation of the “center of a focused spot of the terahertz wave T of 3.0 THz” from the “center of a focused spot of the terahertz wave T of 2.5 THz” was approximately +0.2 mm. In this case, the diameter of the focused spot is approximately 0.5 mm to 0.6 mm. Since the outer diameter of the support area 2a shown in (a) in FIG. 3 was 2 mm, it was found that the focused spot of the terahertz wave T of at least 2.0 THz or more to 3.0 THz or less was substantially contained in the support area 2a having an outer diameter of 2 mm.

(b) in FIG. 3 is a view showing a focused state of the terahertz wave T according to a second simulation. Conditions for the second simulation differ from the conditions for the first simulation described above only in that “the distance from the intersection point between the optical axis A2 and the mirror surface 4a of the first off-axis parabolic mirror 4 to the intersection point between the optical axis A2 and the support area 2a” was set to 140 mm and “the distance from the intersection point between the optical axis A2 and the mirror surface 4a of the first off-axis parabolic mirror 4 to the center of the first lens 5” was set to 100 mm. In this case, the distance from the light source 3 to the support area 2a is 190 mm.

As a result of the second simulation, as shown in (b) in FIG. 3, the amount of deviation of the “center of a focused spot of the terahertz wave T of 2.0 THz” from the “center of a focused spot of the terahertz wave T of 2.5 THz” was approximately −0.1 mm, and the amount of deviation of the “center of a focused spot of the terahertz wave T of 3.0 THz” from the “center of a focused spot of the terahertz wave T of 2.5 THz” was approximately +0.1 mm. In this case, the diameter of the focused spot is approximately 0.5 mm to 0.6 mm. Since the outer diameter of the support area 2a shown in (b) in FIG. 3 was 2 mm, it was found that the focused spot of the terahertz wave T of at least 2.0 THz or more to 3.0 THz or less was substantially contained in the support area 2a having an outer diameter of 2 mm. However, the sum of the light amounts of the terahertz waves T contained in the support area 2a in the second simulation decreased by approximately 38% compared to the sum of the light amounts of the terahertz waves T contained in the support area 2a in the first simulation. However, the sum of the light amounts of the terahertz waves T contained in the support area 2a in the second simulation is sufficient for spectroscopic analysis. If the distance from the light source 3 to the support area 2a is set to 200 mm or less, a light amount sufficient for performing spectroscopic analysis can be obtained.

### MODIFICATION EXAMPLES

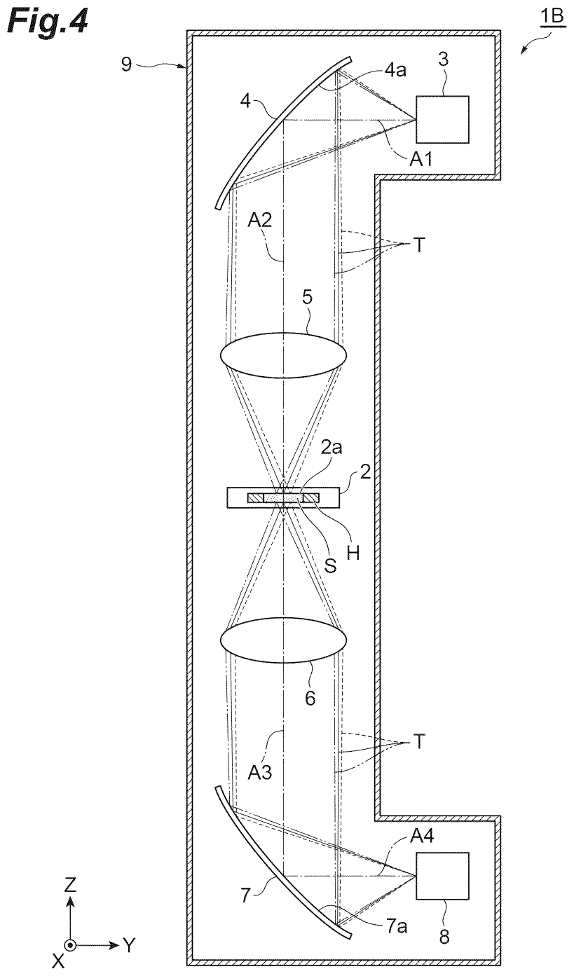

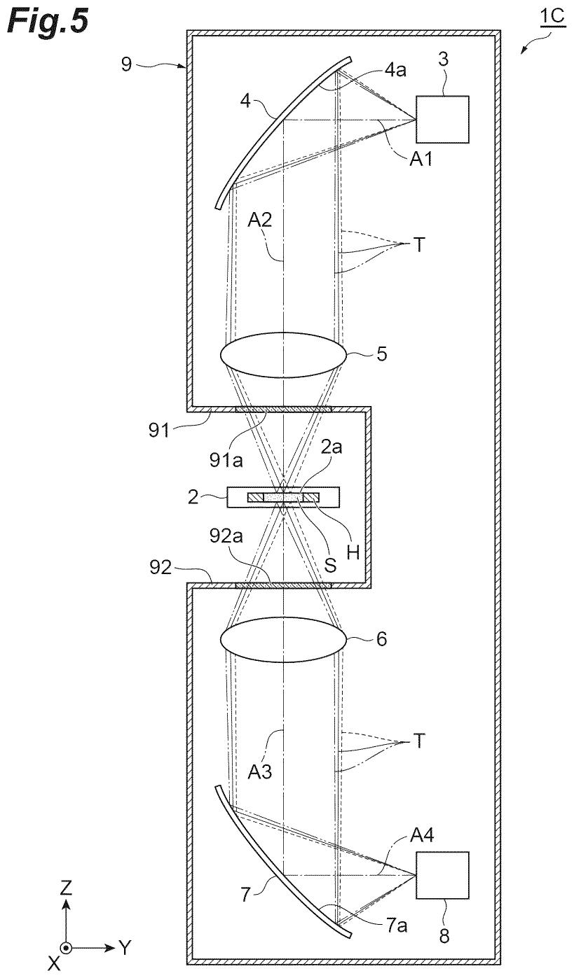

The present disclosure is not limited to the above-described embodiment. For example, as in a spectroscopic analysis device 1B shown in FIG. 4, the support portion 2 may be disposed inside the housing 9, together with the light source 3, the first off-axis parabolic mirror 4, the first lens 5, the second lens 6, the second off-axis parabolic mirror 7, and the photodetector 8. In addition, as in a spectroscopic analysis device 1C shown in FIG. 5, the first portion of the housing 9 that accommodates the light source 3, the first off-axis parabolic mirror 4, and the first lens 5 and the second portion of the housing 9 that accommodates the second lens 6, the second off-axis parabolic mirror 7, and the photodetector 8 may be continuous with each other. In addition, when viewed in the Z direction, the outer diameter of the first window portion 91a may be smaller than 1 time the outer diameter of the support area 2a, or may be larger than 10 times the outer diameter of the support area 2a. In addition, at least one of the second lens 6 and the second off-axis parabolic mirror 7 may not be disposed on an optical path from the support area 2a to the photodetector 8. In addition, the frequency range of the terahertz wave T emitted from the light source 3 is not limited to 0.5 THz or more and 5.0 THz or less.

### REFERENCE SIGNS LIST

1A, 1B, 1C: spectroscopic analysis device, 2: support portion, 2a: support area, 3: light source, 4: first off-axis parabolic mirror, 5: first lens, 6: second lens, 7: second off-axis parabolic mirror, 8: photodetector, 9: housing, 10: quantum cascade laser element, 20: movable diffraction grating, 20a: diffraction grating pattern, 91: first wall, 91a: first window portion, 92: second wall, 92a: second window portion, L1: first light, L2: second light, S: sample, T: terahertz wave.

1. A spectroscopic analysis device comprising:
a support portion that supports a sample so as to include a predetermined support area;
a light source that emits a terahertz wave in a predetermined frequency range;
a first off-axis parabolic mirror that collimates the terahertz wave emitted from the light source;
a first lens that focuses the terahertz wave onto the support area, the terahertz wave being collimated by the first off-axis parabolic mirror; and
a photodetector that detects the terahertz wave with which the sample is irradiated,
wherein the light source includes a quantum cascade laser element that generates a first light of a first frequency and a second light of a second frequency, and that emits the terahertz wave of a difference frequency between the first frequency and the second frequency, and a movable diffraction grating that constitutes an external resonator for the first light, and that changes the first frequency by changing an angle of a diffraction grating pattern with respect to the quantum cascade laser element,
a distance from the light source to the support area via the first off-axis parabolic mirror and the first lens is 10 mm or more and 200 mm or less,
an effective diameter of the first lens is 5 mm or more and 80 mm or less, and
an outer diameter of the support area is 0.5 mm or more and 3.5 mm or less.

2. The spectroscopic analysis device according to claim 1, further comprising:
a second lens that collimates the terahertz wave with which the sample is irradiated.

3. The spectroscopic analysis device according to claim 1, further comprising:
a second off-axis parabolic mirror that focuses the terahertz wave onto the photodetector, the sample being irradiated with the terahertz wave.

4. The spectroscopic analysis device according to claim 1, further comprising:
a housing in which a replacement with an inert gas or an evacuation is performed,
wherein at least the light source, the first off-axis parabolic mirror, the first lens, and the photodetector are disposed inside the housing.

5. The spectroscopic analysis device according to claim 4,
wherein the support portion is disposed outside the housing,
the housing includes a first wall and a second wall facing the support area on both sides of the support area,
the first wall is provided with a first window portion that transmits the terahertz wave, and
the second wall is provided with a second window portion that transmits the terahertz wave.

6. The spectroscopic analysis device according to claim 5,
wherein when viewed in a direction in which the support area and the first wall face each other, an outer diameter of the first window portion is 1 time or more and 10 times or less the outer diameter of the support area.

7. The spectroscopic analysis device according to claim 1,
wherein a position of each of the support portion and the photodetector is fixed when the movable diffraction grating changes the angle of the diffraction grating pattern.

8. The spectroscopic analysis device according to claim 1,
wherein a position of each of the first off-axis parabolic mirror and the first lens is fixed when the movable diffraction grating changes the angle of the diffraction grating pattern.

9. The spectroscopic analysis device according to claim 1,
wherein the frequency range is 0.5 THz or more and 5.0 THz or less.
